(19) United States
(12) Patent Application Publication
(10) Pub. No.: US 2014/0182139 A1
(43) Pub. Date: Jul. 3, 2014

(54) Food dispensing device with integral slicer

(71) Applicant: Per Vesterlund, Victorville, CA (US)

(72) Inventor: Per Vesterlund, Victorville, CA (US)

(21) Appl. No.: 13/694,736

(22) Filed: Dec. 31, 2012

(51) Int. Cl. A47J 47/01

(52) U.S. Cl. CPC A47J 47/01
USPC 30/124

(57) ABSTRACT

A solid food, such as cheese, dispenser is provided having a reusable container including a housing with removable top and bottom covers and an interior push member for receiving cheese therein. The push tube contains a push plate for forcing a selected portion of cheese from the top end of the push tube, and a cutting string for slicing of the selected portion. The cutting string is attached at one end to the top end of the housing with the other end attached to the top cover and is manually wound about and pulled through the cheese thereby dispensing the selected portion. Removing the bottom cover provides access to the push plate.

### BACKGROUND OF THE INVENTION

The background of the invention will be discussed in two parts.

1. Field of the Invention

The invention is directed to a solid food dispenser device having the capability of dispensing the food out of an end of a storage compartment and then slicing the food as desired.

2. Description of the Prior Art

Various types of devices are known for containing, dispensing and slicing of solid foods such as cheese and the like. Devices of interest are shown and described in U.S. Pat. No. 1,595,097, U.S. Pat. No. 2,270,935, and U.S. Pat. No. 2,320,386.

### SUMMARY

The foregoing and other objects of the invention are accomplished by providing a reusable tubular configured container including a cheese storage housing having removable top and bottom covers and an interior push tube for receiving the cheese therein. The push tube contains a push plate for forcing a selected portion of the cheese from the top end of the cheese tube, and a cutting string for slicing of the selected portion. The cutting string is attached at one end to the top end of the housing with the other end attached to the top cover. The cutting string is manually wound about and pulled through the cheese thereby dispensing the selected portion. Removing the bottom cover provides access to the push plate.

It is thus an aspect of the present invention to provide an improved container for storage, dispensing and selective slicing of solid foods such as cheese and the like. The foregoing and other objects, features and advantages of the invention will become readily apparent from a reading of the specification when taken in conjunction with the drawings in wherein like reference numerals refer to like elements in the several views.

### DRAWINGS

FIG. 1 is a perspective view of a device for containing, cutting and dispensing of solid foods such as cheese and the like in accordance with the invention;

FIG. 2 is an exploded view of the device of FIG. 1 showing individual components of the invention,

FIG. 3 is a cut-away view of the device of FIG. 1 showing the cheese in the interior of the cheese compartment and with the cover removed;

FIG. 4 is a cut-away view of the device of FIG. 1 showing a selected portion of the cheese forced from the cheese container by pressure applied by the push plate; and

FIG. 5 is a cut-away view of the device of FIG. 1 showing the selected portion of the cheese sliced by the cutting string.

### DESCRIPTION

The invention is directed to a food dispenser with the capability of smoothly and easily advancing the food out of the end of a storage compartment with the food then sliced as desired. While any suitable solid food such as cheese, butter, pate, salami, etc. can be used with the invention, for brevity the invention will be described with reference to cheese.

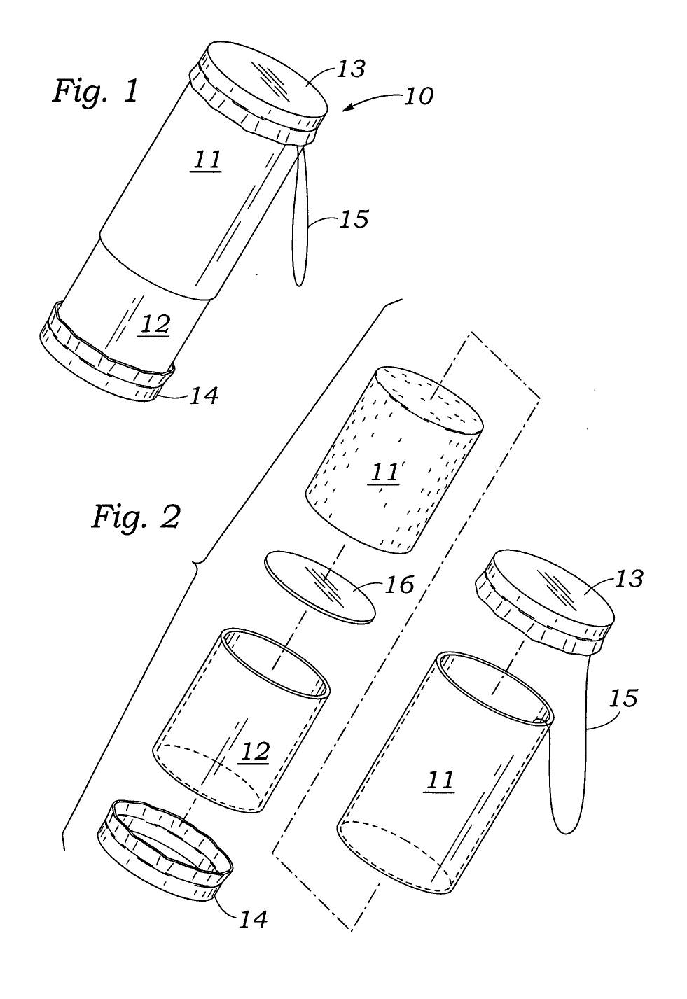

Referring to the drawings in general, and initially to FIG. 1, there is shown in perspective view a device for containing, cutting and dispensing of solid foods such as cheese and the like in accordance with the invention. Generally designated 10, the device is shown tubular in configuration and including a housing 11, push tube 12, removable top cap and bottom cap 13 and 14, respectively, and a cutting string 15.

FIG. 2 is an exploded view of the device of FIG. 1 showing the disc shaped push plate 16 and the cheese 17. Push plate 16 has a diameter slightly less than the diameter of push tube 12 to thus permit its slidable insertion crosswise into push tube 12, that is, plate 16 being perpendicular to the circular wall of push tube 12 and crosswise to span the interior of push tube 12.

The method of assembly is indicated whereby push tube 12 receives push plate 16 and cheese 17, cheese 17 being inserted into the top of push tube 12 and abutting crosswise positioned push plate 16. Housing 11 is fitted over the combination of the push tube 12, push pate 16 and cheese 17. Bottom cover 14 is fitted onto the bottom of push tube 12 and top cover 13 is fitted onto the top of housing 11. Bottom cover 14 is removable to provide access to push plate 12 whereby the cheese 17 can be forced upward within the push tube 12.

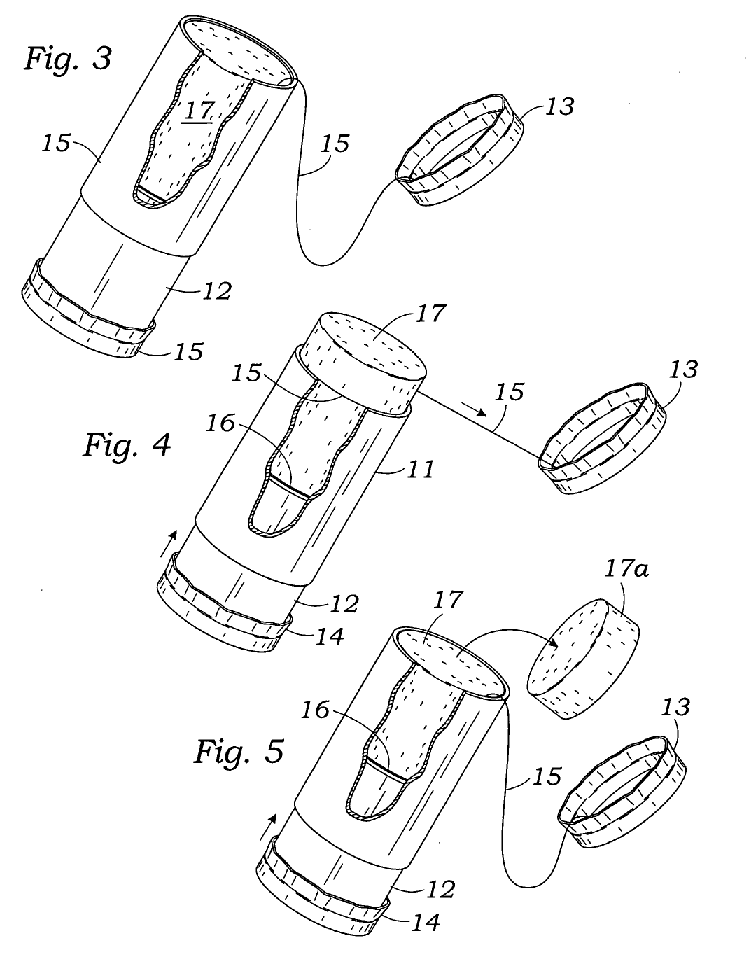

FIG. 3 illustrates the device 10 assembled with the top cover 13 removed. In cut-away view the cheese 17 is shown inserted into the push tube 12.

FIG. 4 illustrates the device 10 assembled with the top cover 13 removed and a selected portion of the cheese 17 pushed out of the push tube 12 by pushing against the bottom of the push plate 16. Manually advancing the push plate 16 advances the cheese 17 to the thickness of cheese 17 to be been sliced by the cutting string 15.

Slicing of the cheese 17 is accomplished by winding the cutting string 15 about the exposed portion of cheese 17 and manually pulling the cutting wire through the cheese 17. After slicing of the portion 17a, the push plate 16 is then advanced to move the cheese 17 upwardly another increment of distance and the steps repeated. When sufficient cheese has been sliced, the top cap 13 is remounted to the housing 11 to thereby push the cheese back into the push tube 11.

Although not shown, the housing 11 can include a strip of transparent material for determining the amount of cheese 17 remaining in the device 10.

While the preferred embodiments of the invention have been illustrated and described, it should be understood that variations will be apparent to one skilled in the art without departing from the principles herein. Accordingly, the invention is not to be limited to the specific embodiments illustrated in the drawings.

What is claimed is:

1. A food dispensing device comprising:
A generally circular housing having a removable top cap;
A generally circular push tube dimensioned for slidable insertion within said housing and having a removable bottom cap;
a disc shaped push plate having a diameter dimensioned for slidable positioning within said push tube, said push plate positioned perpendicular to the circular wall of said push tube and crosswise thereof to span the interior of said push tube; and
a cutting string attached at one end to the top of said housing and the other end attached to said top cover.

2. The food dispensing device of claim 1 wherein said top cover is removed and a selected portion of said cheese pushed out of the push tube by pushing against the bottom of said push plate thereby advancing the push plate and exposing a portion of said cheese from said push tube with slicing of the exposed portion of said cheese accomplished by winding said cutting string about the exposed portion and pulling said cutting string through said cheese.

3. The food dispensing device of claim 3 wherein said push plate is advanced to move said cheese upwardly to sequentially expose portions of said cheese from said push tube for slicing by said cutting string.

4. The food dispensing device of claim 3 wherein upon completion of slicing of said cheese the top cap is remounted to said housing to thereby push said cheese back into said push tube.

5. The food dispensing device of claim 3 wherein said push tube includes a partially light transmitting area for determination of the amount of said cheese remaining in said push tube.

6. A solid food dispenser comprising:
a housing having at its top end a releasable top cap, said housing connected to said top cap by a flexible cutting string;
a food container slidably positionable within said housing and having a releasable bottom cap;
pusher means accessible through the bottom of said container and positionable within said container for advancing said food from the top of said container whereby a portion of said food is sliced by manipulating said cutting string.

7. The food dispensing device of claim 6 wherein said housing and said container are tubular and said pusher means includes
a disc shaped push plate having a diameter dimensioned for slidable positioning within said container, said push plate positioned perpendicular to the circular wall of said container and crosswise to span the interior of said container.
